(19) United States
(12) Patent Application Publication
(10) Pub. No.: US 2025/0278667 A1
(43) Pub. Date: Sep. 4, 2025

(54) PREDICTING DOCUMENT IMPACT USING A MACHINE LEARNING MODEL

(71) Applicant: Microsoft Technology Licensing, LLC, Redmond, WA (US)

(72) Inventors: Sudipto MUKHERJEE, Bellevue, WA (US); Liang DU, Redmond, WA (US); Robin ABRAHAM, Redmond, WA (US)

(73) Assignee: Microsoft Technology Licensing, LLC, Redmond, WA (US)

(21) Appl. No.: 18/591,902

(22) Filed: Feb. 29, 2024

(51) Int. Cl. G06N 20/00

(52) U.S. Cl. CPC G06N 20/00

(57) ABSTRACT

This document relates to predicting the impact of documents using a trained machine learning model. For instance, the disclosed implementations can train a gradient-boosted decision tree or neural network to predict impact scores of previously-published documents using features such as author features, journal features, document metadata features, and/or text embeddings representing text from the previously-published documents. Once trained, the machine learning model can be employed to predict impact scores of newly-published documents. The impact scores can be employed for operations such as ranking the newly-published documents in response to a received query.

### BACKGROUND

One important use case for computing devices involves ranking documents relative to one another. For instance, when a user submits a query to a web search engine, the web search engine can return a ranked list of documents in response to the query. Web pages can be ranked based on various factors such as the content of each web page, context information such as user location, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for analyzing documents. One example includes a method or technique that can be performed on a computing device. The method or technique can include accessing a plurality of first documents. The method or technique can also include determining respective impact scores of the first documents based on references to the first documents in other documents. The method or technique can also include obtaining first features relating to the first documents. The method or technique can also include inputting the first features to a machine learning model. The method or technique can also include training the machine learning model to predict the respective impact scores of the first documents based on the first features. The method or technique can also include outputting the trained machine learning model, the trained machine learning model being adapted to predict second impact scores of second documents based on second features relating to the second documents.

Another example includes a method or technique. The method or technique can include obtaining a trained machine learning model that has been trained to predict respective impact scores of first documents based on first features relating to the first documents. The method or technique can also include obtaining second features relating to second documents. The method or technique can also include inputting the second features to the trained machine learning model. The method or technique can also include receiving, from the trained machine learning model, predicted impact scores reflecting predicted impacts of the second documents. The method or technique can also include receiving a query. The method or technique can also include identifying individual second documents that match the query. The method or technique can also include ranking the individual second documents relative to one another based on the predicted impact scores. The method or technique can also include responding to the query with ranked individual second documents.

Another example entails a system that includes a processor and a storage medium storing instructions. When executed by the processor, the instructions can cause the system to obtain a trained machine learning model that has been to predict respective impact scores of first documents based on first features relating to the first documents. The instructions can also cause the system to obtain second features relating to second documents. The instructions can also cause the system to input the second features to the trained machine learning model. The instructions can also cause the system to receive, from the trained machine learning model, predicted impact scores reflecting predicted impacts of the second documents. The instructions can also cause the system to receive a query. The instructions can also cause the system to identify individual second documents that match the query. The instructions can also cause the system to rank the individual second documents relative to one another based on the predicted impact scores. The instructions can also cause the system to respond to the queries with ranked individual second documents.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example workflow for predicting document impact, consistent with some implementations of the present concepts.

FIG. 2 illustrates example timelines of features for predicting document impact, consistent with some implementations of the present concepts.

FIG. 3 illustrates an example table that maps reference counts to relevance labels, consistent with some implementations of the present concepts.

FIG. 4 illustrates an example table of features that can be employed by a machine learning model for predicting document impact, consistent with some implementations of the present concepts.

FIG. 5 illustrates an example results table of ranked results based on predicted impact scores, consistent with some implementations of the present concepts.

FIG. 6 illustrates an example of a system in which the disclosed implementations can be performed, consistent with some implementations of the present concepts.

FIG. 7A illustrates a first example method or technique, consistent with some implementations of the present concepts.

FIG. 7B illustrates a second example method or technique, consistent with some implementations of the present concepts.

FIGS. 8A and 8B illustrate an example graphical user interface that can be employed with some implementations of the present concepts.

FIGS. 9A and 9B illustrate experimental results obtained using some implementations of the present concepts.

### DETAILED DESCRIPTION

### Overview

As noted above, ranking of documents for their relevance to a query is an important information retrieval task. There are various ways to assess the relevance of a given document to a given query, such as keyword similarity, clickthrough rates of individual documents that match a query, etc. These approaches generally work well for documents that have been available for a reasonable period of time, but do not typically attempt to predict how documents may become increasingly more significant in the future.

Some types of documents, such as academic papers, often receive citations from other documents as sources of information. For instance, one academic paper might cite another academic paper for a specific computing algorithm or medical study. Over time, it is possible to determine that a document that receives many citations as a source of information can be considered more impactful in a given field than another document in that field that receives relatively few citations.

However, while this approach works for documents that have been available for long enough to evaluate whether other documents cite to them frequently, it does not work for recently-published documents. This is because when a document first becomes available (e.g., published in a journal or on the Internet), the other documents existing at the time do not have citations or other references to the newly-available document. Thus, it is hard to assess the impact of the newly-available documents relative to one another. As a consequence, it is difficult to consider the relative impact of newly-published documents when ranking those documents relative to one another.

The disclosed implementations can employ a machine learning approach to predict impact scores of documents (e.g., recently-published documents) based on various features. The impact scores can reflect a prediction as to how impactful each document will be relative to other documents, e.g., in the same subject matter domain. For instance, the features can include author features relating to an author of a given document, journal features relating to a publication (such as a journal) in which the document is initially published, metadata features relating to document metadata for the document, and or text embeddings that represent content of the document. The machine learning model can be trained based on impact scores of other (e.g., older) documents that reflect the number of times each of the older documents has been referenced via footnotes, endnotes, hyperlinks, etc. The predicted impact scores can be employed to rank documents relative to one another in response to a query. In addition, the machine learning model and the predicted impact scores can be periodically updated over time to reflect changes in various considerations such as the reputations of different authors, reputations of different publications (e.g., journals), and/or to the type of content that is considered significant within a particular subject matter domain.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network.

Another type of machine learning model is a decision tree. A decision tree is a model that uses non-leaf nodes to represent features and leaf nodes to represent predicted classes or class probabilities (for classification analysis) or predicted real numbers (for regression analysis). One way to train a decision tree involves gradient boosting, where decision trees are incrementally trained as weak learners. Each new weak learner is trained to correct errors in a previous weak learner. A final strong model can be obtained by aggregating the results of each of the weak learners.

### Terminology

The term “machine learning model” refers to any of a broad range of models that can learn from training data. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The term “references” refers to instances where a given document is referred to by another document. For instance, one type of reference is a “citation,” e.g., academic white papers can include endnotes or footnotes as citations to another document. Another type of reference is a “link,” such as a URL, that can be used to retrieve a given document over a network. In some implementations, a particular term can be considered a reference to a given document, e.g., the term “Faster R-CNN” can be considered a reference to a particular computer vision model (Ren, et al., “Faster R-CNN: Towards Real-Time Object Detection with Region Proposal Networks,” Advances in Neural Information Processing Systems, 2015, 28). The term “publication” refers to a source for a given document. For instance, one type of publication is a “journal,” e.g., a source of peer-reviewed academic or scientific articles. Another type of publication is a website that hosts web documents accessible over the Internet.

The term “feature” refers to data that is used as an input to a machine learning model. For instance, features can represent the author of a given document, a journal or other publication in which that document appears, and/or metadata of the document. In some cases, embeddings representing the text of a given document can also be used as features by a machine learning model.

Features can be input to a machine learning model to obtain an impact score. The impact score can be a real value that reflects the predicted impact of a given document within a particular subject matter domain. For instance, the predicted impact score for a given document can correspond to a predicted number of references to that document or a predicted relevance label for that document. A relevance label is a value that reflects the impact of a given document, and can be derived from the number of references to that document in other documents.

### Example Workflow

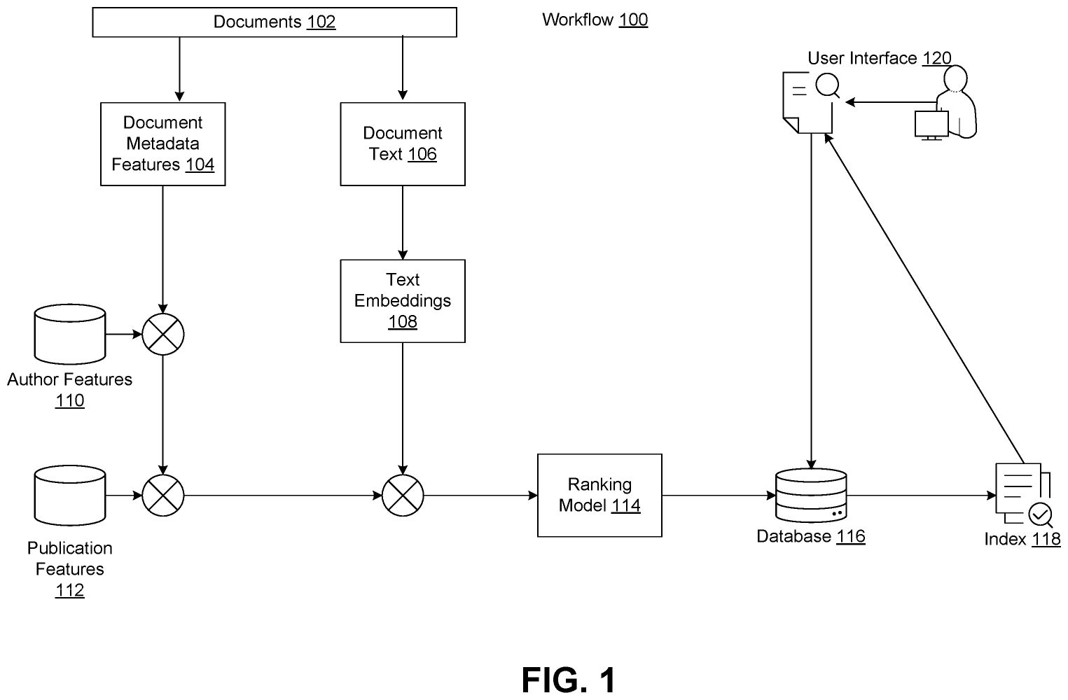

FIG. 1 illustrates an example workflow 100 for predicting the future impact of documents. First, documents 102 are processed to extract document metadata 104, which can include information such the publication type for a given document (conference publication, book, etc.), number of authors of that document, etc. The documents are also processed to obtain document text 106, which can be mapped into text embeddings 108. For instance, document fields such as the title and/or abstract can be input to a transformer-based language model to obtain the embeddings. Suitable models include BERT-based language models or GPT-based generative models.

In addition, author features 110 can be obtained for the authors of a given document. The author features can reflect the publication history and/or reputation of the authors of a given document. As discussed more below, the author features can be aggregated when a document has multiple authors. Publication features 112 can also be obtained, where the publication features reflect the reputation of a publication in which a given document appears.

The metadata features 104, text embeddings 108, author features 110, and/or publication features 112 can be used to train a ranking model 114. The ranking model can be used to generate predicted impact scores for documents that are used to populate a database 116 (e.g., a SQL or NoSQL database). The database record for each individual document can include the predicted impact score for that document as well as authors, publications, and/or publication dates for each document. As discussed more below, this can facilitate efficient retrieval of the documents in response to queries with filtering criteria relating to authors, publications, and/or publication dates.

The documents 102 can also be represented in an index 118 that allows for searching the documents, e.g., by matching query embeddings to document embeddings. A user interface 120 allows a user to submit queries that can be used to find matching documents via the indexer, and the documents can be retrieved from the database 116 and ranked relative to one another based on the predicted impact scores stored in the database.

### Example Timelines

Generally speaking, the author features and publication features for a given document can be obtained from historical data prior to the publication of a given document. Conversely, references to a given document can be obtained after a given document is published. One convenient way to group documents for subsequent processing is by publication year, as described below.

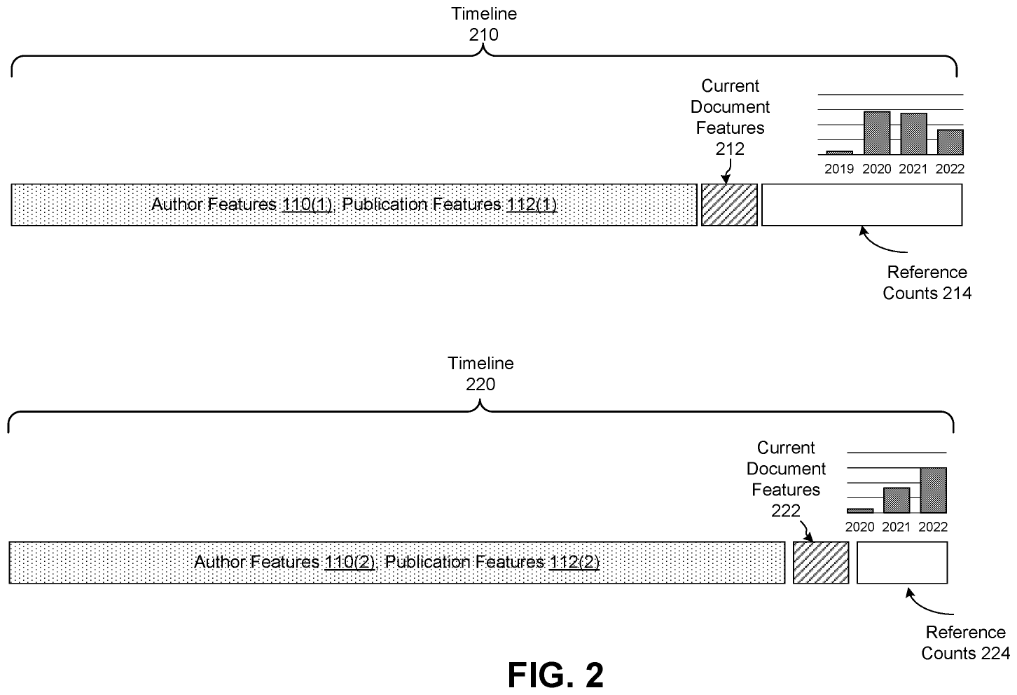

FIG. 2 illustrates a first timeline 210 for a document published in the year 2017 and a second timeline 220 for a document published in the year 2019. First timeline 210 includes current document features 212 for the document published in 2017, e.g., document metadata features and/or text embeddings for that document. The author features 110(1) for authors of the document published in 2017 and the publication features 112(1) for the publication in which that document was published can be obtained for prior years, e.g., 2016 and earlier. Reference counts 214 can be obtained for years after 2017, e.g., 2018-2022. The reference counts can include any instance where another document referred to the document published in 2017.

Second timeline 220 includes current document features 222 for the document published in 2019, e.g., document metadata features and/or text embeddings for that document. The author features 110(2) for authors of the document published in 2019 and the publication features 112(2) for the publication in which that document was published can be obtained for prior years, e.g., 2018 and earlier. Reference counts 224 can be obtained for years after 2019, e.g., 2020-2022. The reference counts can include any instance where another document referred to the document published in 2019.

Note that, in some cases, documents published in different years can have one or more authors in common and/or appear in the same publication. However, the author and/or publication features used for these documents can be different, because the author and publication features can change over time. As a consequence, the author and/or publication features used during training and/or inference (e.g., impact score prediction) for different documents can vary even when those document share authors and/or publications.

To ensure author and journal features remain constant for a given period of time (for example, a year), they can be cached so that impact scores can be computed with stored features for all newly published papers in the same period of time. These author and/or publication features can be refreshed from time to time based on the use case, e.g., weekly, quarterly or annually, while also retraining the ranking model 114. Impact scores determined using the ranking model may be used to rank papers published in a similar time period (e.g., within the same year).

### Example Relevance Labels

As described elsewhere herein, it is possible to train a model using a regression approach to predict the number of references that a given document will receive. However, reference counts can be very noisy, and this can negatively impact model training. One approach for dealing with noisy reference counts is to map reference counts to relevance labels, as described more below.

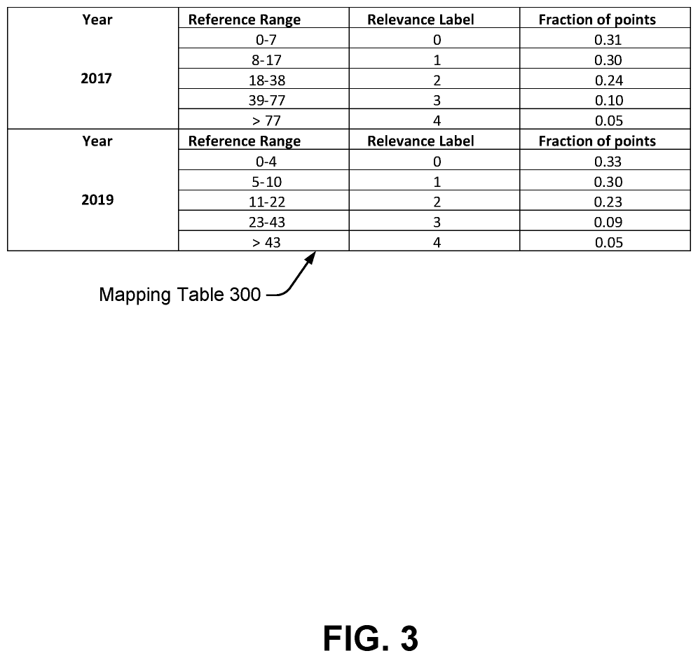

FIG. 3 illustrates a mapping table 300 that maps reference counts to corresponding relevance labels for the years 2017 and 2019. Here, the relevance labels are provided as integers that represent the respective impact of a given document. Note that the reference ranges for the relevance labels differ by year. For instance, for documents published in 2017, a relevance label of 2 is assigned to those documents that received between 18 and 38 references in the subsequent years. In contrast, for documents published in 2019, a relevance label of 2 is assigned to those documents that received between 11 and 22 references in the subsequent years.

Note that the number of references that documents tend to receive can grow over time. As a consequence, it can be useful to adjust the reference ranges that are mapped to each relevance label over time. The “fraction of points” column of mapping table 300 can be employed to determine the appropriate reference ranges for different time periods. The “fraction of points” column indicates the relative percentage of documents in each reference range, e.g., 31% of the documents for 2017 received between 0 and 7 references, while 33% of the documents for 2019 received between 0 and 4 references. This approach allows the relevance labels for 2017 vs. 2019 documents to represent comparable “tiers” of documents, even though the actual reference ranges are different for each tier in 2017 vs. 2019

### Example Features

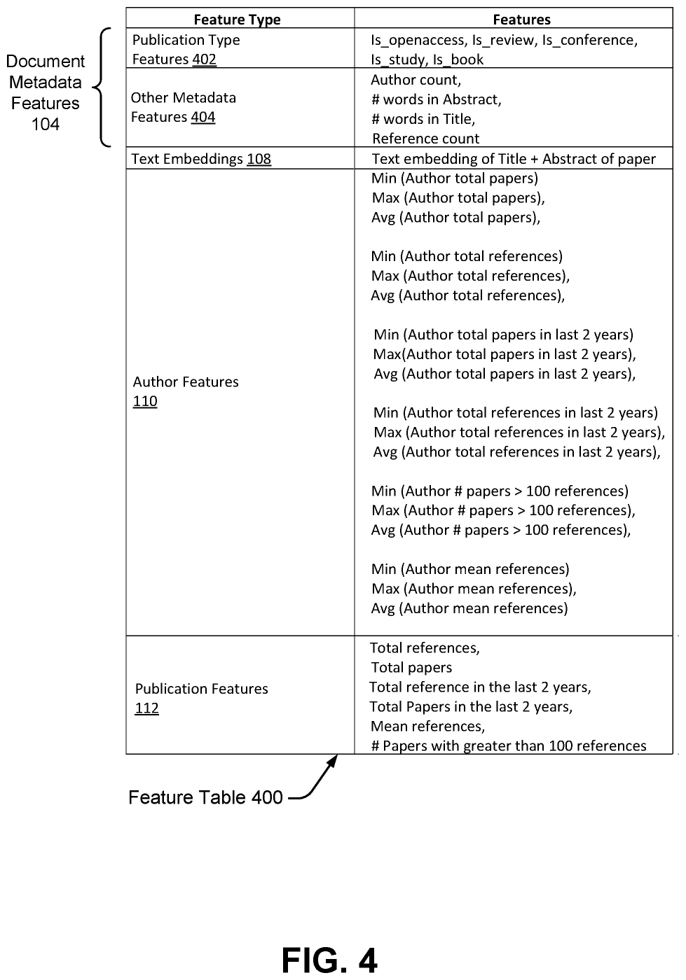

There are various features that could be employed to train a ranking model for subsequent prediction of impact scores. FIG. 4 illustrates an example feature table 400 showing some specific examples of features that can be employed to implement the disclosed concepts. Feature table 400 includes document metadata features 104, text embeddings 108, author features 110, and publication features 112.

The document metadata features 104 can include publication type features 402 and other metadata features 404. The publication type features can include features indicating whether the document appears in an open-access publication (e.g., available without a subscription), whether the document appears in a peer-reviewed publication, whether the document appears in a publication associated with a conference, whether the document includes a study or is a book, etc. The other metadata features can include features reflecting the number of authors on a given document, the number of words in the abstract or title, the number of references in that document to other documents, etc.

The text embeddings 108 can be obtained by mapping the title and/or abstract of the document to an embedding vector. For instance, the title and/or abstract text can be processed using a transformer-based natural language processing model such as a BERT or GPT variant to obtain the embeddings. In some cases, the model can be trained for a particular type of publication, e.g., SciBERT (Beltagy, et al., “SciBERT: A pretrained language model for scientific text”, 2019, arXiv preprint arXiv: 1903.10676) is a BERT-style model that is pretrained on a corpus of scientific papers and can be employed for documents relating to scientific subject matter domains (e.g., biology, chemistry, physics, etc.).

The author features 110 can represent aggregate information for authors of a given document, e.g., collected from each author's publication history prior to the publication of that document. For instance, the minimum, maximum, and average number of papers authored by the authors of a given document can be included as author features. As another example, the minimum, maximum, and average values of the number of references that the authors' published documents have received can also be included as author features. Because the reputation of an author can change over time, it can be useful to capture similar author features that are limited to a recent time period, e.g., the numbers of papers or references from the past two years can be included as a separate set of features. In addition, the minimum, maximum, and average number of papers that received more than 100 references and the minimum, maximum, and average of the mean number of references received by each author can also be employed.

The publication features 112 can include information relating to a publication (e.g., a scientific journal) in which a given document is published. For instance, the publication features can reflect the total number of references to all documents that appeared in that publication, the total number of papers (or other documents) that appeared in that publication, etc. In addition, similar features can be included but limited to a recent period of time, e.g., two years, to account for recent changes to the reputation of a given publication. Further, the mean number of references to papers (or other documents) that appear in that publication as well as the number of papers (or other documents) that have received over 100 references and appeared in that publication can also be employed as features.

### Example Ranked Results

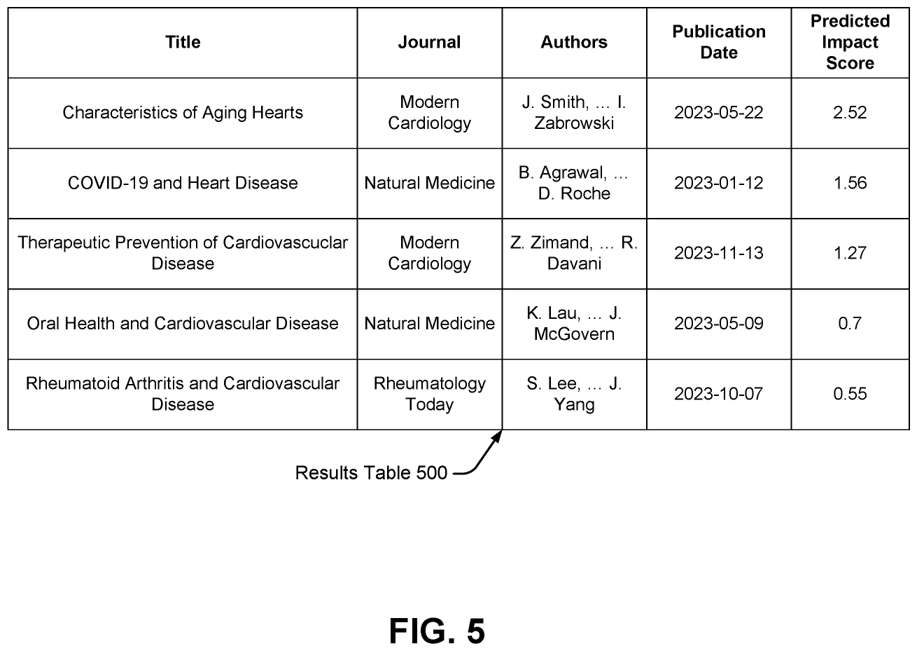

As noted previously, impact scores predicted by ranking model 114 can be employed to rank individual documents relative to one another. FIG. 5 illustrates an example results table 500. For the purposes of example, assume that a user queries for documents relating to cardiovascular disease that were published in 2023. Further, assume that five papers are identified as matching the query. Ranking model 114 can be employed to predict an impact score for each matching document. The documents can then be ranked relative to one another based on the predicted impact scores. Here, the predicted impact scores can serve as a proxy for relevance labels as described previously. As also noted, however, some implementations can predict the raw reference counts directly, e.g., using a regression model.

### Example System

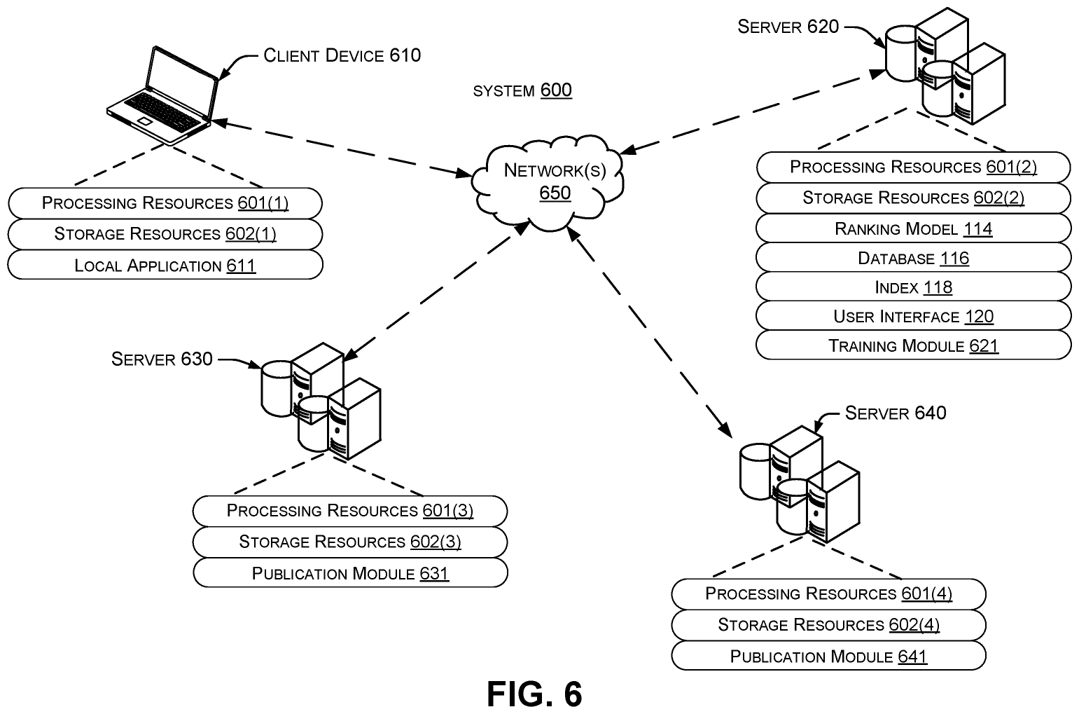

The present implementations can be performed in various scenarios on various devices. FIG. 6 shows an example system 600 in which the present implementations can be employed, as discussed more below.

As shown in FIG. 6, system 600 includes a client device 610, a server 620, a server 630, and a server 640, connected by one or more network(s) 650. Note that the client device can be embodied as a mobile device such as a smart phone or tablet, as well as a stationary device such as a desktop, server device, etc. Likewise, the servers can be implemented using various types of computing devices. In some cases, any of the devices shown in FIG. 6, but particularly the servers, can be implemented in data centers, server farms, etc.

Certain components of the devices shown in FIG. 6 may be referred to herein by parenthetical reference numbers. For the purposes of the following description, the parenthetical (1) indicates an occurrence of a given component on client device 610, (2) indicates an occurrence of a given component on server 620, (3) indicates an occurrence on server 630, and (4) indicates an occurrence on server 640. Unless identifying a specific instance of a given component, this document will refer generally to the components without the parenthetical.

Generally, the devices 610, 620, 630, and/or 640 may have respective processing resources 601 and storage resources 602, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 610 can include a local application 611. The local application can be a web browser or another application that allows the user to interact with server 620. Server 620 can allow the user to search documents via user interface 120. For instance, the user can query for documents and provide various filtering criteria to server 620. Server 620 can identify documents that match the query terms in index 118, and/or identify documents that match filtering criteria in database 116. Then, server 620 can retrieve the predicted impact scores for each matching document from the database, and rank the matching documents relative to one another based on the predicted impact scores.

Server 620 can obtain the documents that are indexed and processed with the ranking model 114 from publication module 631 on server 630 and publication module 641 on server 640. For instance, the publication modules can be implemented as web services that allow server 620 to download individual documents as well as associated metadata. In some cases, each publication module corresponds to a different publication, e.g., portals to different scientific journals.

### Example Training Method

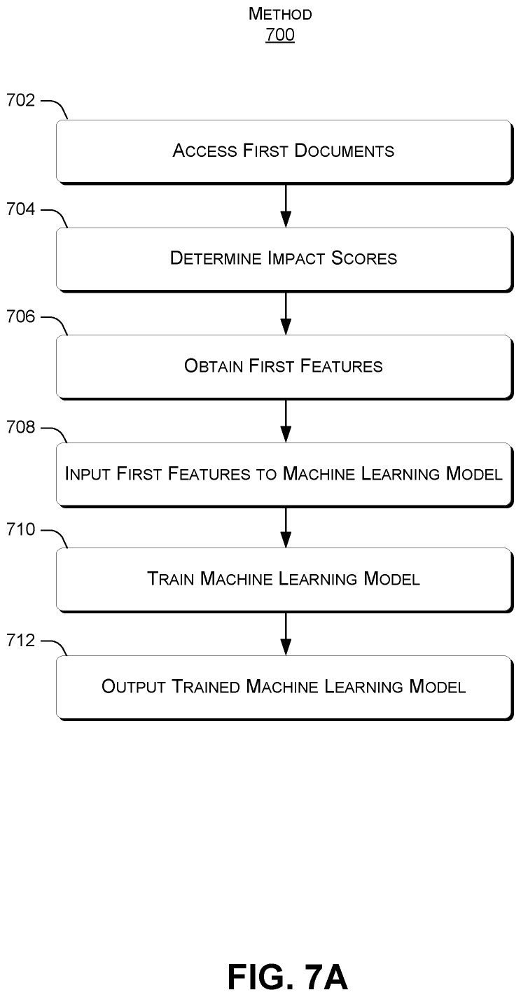

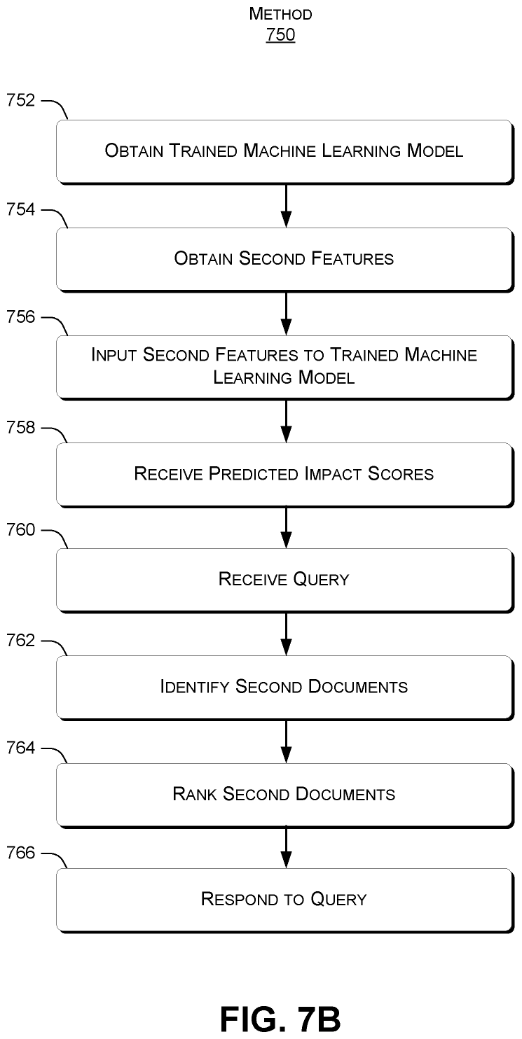

FIG. 7A illustrates an example method 700 for training a machine learning model to predict impact scores of documents, consistent with some implementations of the present concepts. Method 700 can be implemented on many different types of devices, e.g., by one or more cloud servers, by a client device such as a laptop, tablet, or smartphone, or by combinations of one or more servers, client devices, etc.

Method 700 begins at block 702, where first documents are accessed. For instance, the documents can be academic papers, web pages, blogs, news articles, etc. The documents can be accessed via web services that publish the documents, via search engines, or via other network-accessible document sources.

Method 700 continues at block 704, where impact scores are obtained for the first documents. The impact scores can be based on references to the first documents that appear in other documents. For instance, the references can be endnotes or footnotes to the first documents, hyperlinks to the first documents, terms that refer to the first documents, etc. The impact scores can be represented as raw reference counts or mapped to relevance labels as previously discussed with respect to mapping table 300.

Method 700 continues at block 706, where first features relating to the first documents are obtained. As noted above, the features can include document metadata features, text embeddings, author features, publication features, etc. Generally speaking, the author and/or publication features can be obtained for time periods prior to the publication of a given document.

Method 700 continues at block 708, where the first features are input to a machine learning model. For instance, the machine learning model can be a decision tree, a neural network, etc.

Method 700 continues at block 710, where the machine learning model is trained to predict the impact scores for the first documents. For instance, the machine learning model can be trained to predict the raw reference counts using a regression approach based on a mean squared error metric as a loss function. As another example, the machine learning model can be trained to predict a ranking for the first documents based on a ranking loss. For instance, the ranking loss can be a normalized discounted cumulative gain for the predicted rankings obtained using impact scores predicted by the machine learning model relative to actual rankings of the individual first documents determined using reference counts or relevance labels. Relevance labels can be obtained by converting ranges of reference counts to corresponding integers.

Method 700 continues at block 712, where the trained machine learning model is output. For instance, the trained machine learning model can be written to storage, sent over a network to another device, made available via a web service, etc. The trained machine learning model can be adapted, via the training at block 710, to predict impact scores of other documents as described elsewhere herein.

In some cases, some or all of method 700 is performed by a server. In other cases, some or all of method 700 is performed on another device, e.g., a client device. Note that some implementations can periodically obtain further documents (e.g., published at a later time) and perform method 700 again to retrain the machine learning model.

### Example Inference Method

FIG. 7B illustrates an example method 750 for using a trained machine learning model to respond to a query based on predict impacted scores of documents, consistent with some implementations of the present concepts. Method 750 can be implemented on many different types of devices, e.g., by one or more cloud servers, by a client device such as a laptop, tablet, or smartphone, or by combinations of one or more servers, client devices, etc.

Method 750 begins at block 752, where a trained machine learning model is obtained. The trained machine learning model can have been previously trained to predict respective impact scores of first documents based on first features relating to the first documents. As noted above, the trained machine learning model can be a neural network, gradient-boosted decision tree, etc.

Method 750 continues at block 754, where second features relating to second documents are obtained. For instance, the second features can include document metadata features, text embeddings, author features, publication features, etc. Generally speaking, the author and/or publication features can be obtained for time periods prior to the publication of a given document. Note that the second documents can be published during a later time period than the first documents that were used to train the machine learning model.

Method 750 continues at block 756, where the second features are input to the trained machine learning model.

Method 750 continues at block 758, where predicted impact scores are received from the trained machine learning model. The predicted impact scores can be raw predicted reference counts or predicted relevance labels. Block 758 can also include populating a database with the predicted impact scores as well as information such as authors, publications, and/or publication dates for each document.

Method 750 continues at block 760, where a query is received. For instance, the query can specify one or more search terms. The query can also include one or more filtering criteria. For instance, the filtering criteria can request that the query is filtered to return documents with a specific author, published in a specific publication, having a publication date within a specific date range, etc.

Method 750 continues at block 762, where individual second documents that match the query are identified. For instance, a keyword similarity search can be performed against an index of the second documents. The similarity search can be implemented by matching an embedding representing the query to embeddings representing the second documents, which can be stored in the index. For instance, the embeddings can be obtained by mapping titles and/or abstracts of the second documents using a transformer-based language processing model to the embeddings. In addition, the matching documents can be filtered using any filtering criteria associated with the query.

Method 750 continues at block 764, where the individual second documents that match the query and/or filtering criteria are ranked based the predicted impact scores. While the implementations herein use relatively greater real values to represent relatively more impactful documents, other implementations can employ other ways to represent impact scores (e.g., integer representations, classifying documents into impact tiers, etc.).

Method 750 continues at block 766, where a response to the query is provided. For instance, the response can include the individual second documents that match the query as they were ranked at block 754. For instance, the ranked document list can be sent over a network to a device that submitted the query.

In some cases, some or all of method 750 is performed by a server. In other cases, some or all of method 750 is performed on another device, e.g., a client device.

### Example User Interface

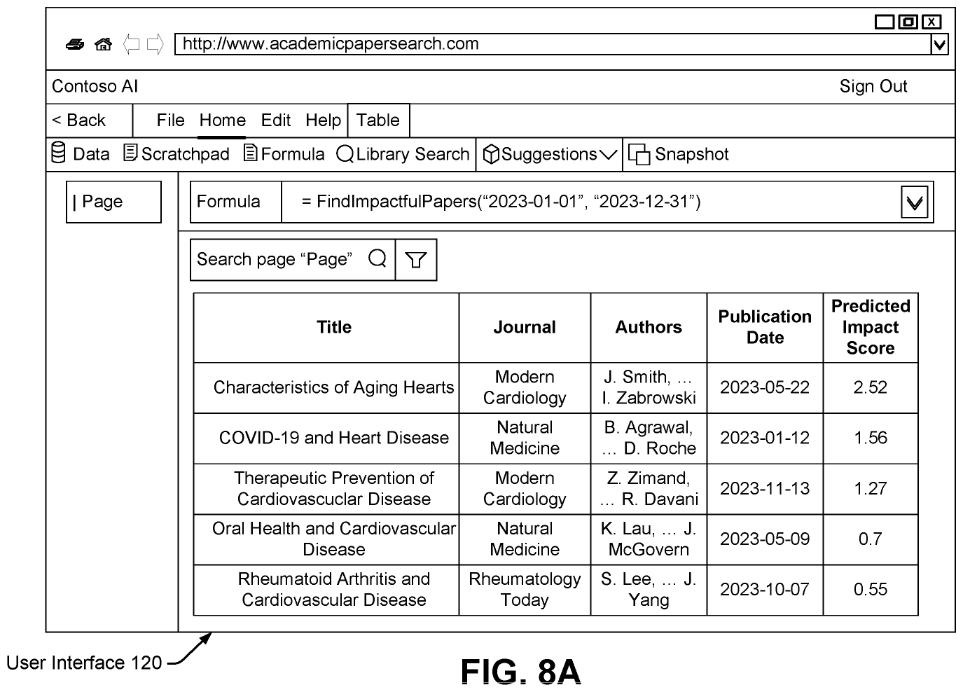

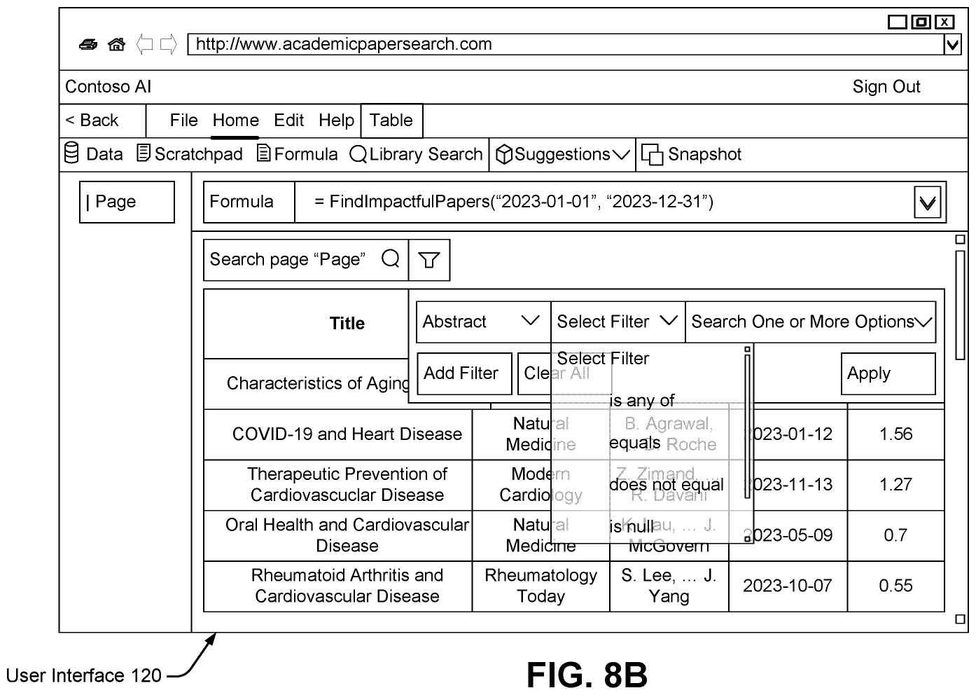

FIG. 8A illustrates one possible configuration for user interface 120. The user interface is shown as a web page, e.g., hosted by server 620 accessible via the url “http://www.academicpapersearch.com.” The web page provides an option for the user to enter a search formula to search for papers that match certain criteria. Here, the user is searching for impactful papers published in 2023. The results shown in FIG. 8 correspond to those shown in results table 500 (FIG. 5).

As shown in FIG. 8B, the user can filter the documents by various criteria using a drop-down menu or other user interface element. For instance, assuming the user were to filter by publication dates after March of 2023, then the second document “COVID-19 and Heart Disease” would be removed from the user interface 120. As another example, if the user were to broaden the publication date range to include the years 2022 and 2023, new matching documents published in 2022 could be retrieved and ranked relative to each other and the documents published in 2023 based on their predicted impact scores. In some cases, impact scores can also be computed for older documents and used as a basis for ranking relative to newer documents. However, because the number of references to documents can change over time, it can be more useful to rank documents published in similar time ranges than documents published far apart in time.

### Specific Implementation and Experimental Results

The techniques described herein were implemented and experiments were conducted to determine the ranking capabilities of different models with different features. First, a bulk download of PubMed abstracts was obtained and joined with a bulk download of paper meta-data information obtained from Semantic Scholar. The acquired data includes bibliographic information such as reference (e.g., citation) counts, publication (e.g., journal) name, publication date, author names and affiliations, title and abstract of the paper, etc. This raw data was utilized to compute features and labels for training ranking models. For instance, historic reference counts were utilized to create author and journal features that are then used for training. Because the following discussion relates to academic papers, the term “citation” and “journal” are used in place of “reference” and “publication” at times.

Utilizing the computed features and labels from historic citation data, a suitable loss function can be used to train the ranking model. As a concrete example, one implementation used to obtain the results provided below used gradient-boosted decision trees with a learning-to-rank framework. Another implementation used a neural network that used a loss function to perform regression on the citation counts.

Note that the disclosed techniques can involve continuously fetching newly published documents, detecting newly published documents that have not yet been scored and incorporating them into a list of existing documents. As noted above, author and journal features can change with time, and thus author and journal features can be periodically refreshed and the ranking model can be retrained with the refreshed features. The dynamic nature of the disclosed techniques ensures that users have access to the most relevant and impactful papers at any given time. As a concrete example, newly-published documents were scored using the ranking model and the scores were stored, along with document meta-data, in a NoSQL database. This enables the user to query specific author(s), journal(s) and/or filter by publication date to surface impactful papers in a required time range.

This implementation allows users to search documents by keywords and retrieve a ranked list of documents for a particular topic. The ranked list of documents is presented to users in a manner where search functionality, filtering options and customizable ranking criteria are available. As a concrete implementation, the Title and Abstract of documents can be indexed using a vector-search service so that keyword-based similarity search is possible. This enables topic-focused retrieval of impactful papers.

Note that different subject domains can have different citation levels and it can be difficult to compare across diverse subject domains such as Medicine and Mathematics. An impactful paper in Medicine might garner 10,000 citations in 5 years while an impactful paper in Mathematics might gather 500 citations in 5 years. Thus, some implementations can train separate ranking models for different subject matter domains. The experiments discussed below were conducted using papers in the subject matter domain of Biochemistry; hence the universe of papers to rank are all recently published PubMed papers.

Consider the following definition of impact: If P and Q are two papers published in the same year, then P is more impactful than Q if P receives T (T>1) times more than citations that Q in the same time span after publication. Example—assume documents P and Q are both published in 2015. P receives 200 citations in 2020. Q receives 10 citations in 2020. Then, P is more impactful than Q.

Given this definition of impact, the following approach was employed to train the ranking model on historical citation data, without incorporating information about the future. For example, when obtaining labels to rank papers after 2015, the author and journal features are constructed with data until the end of 2014. Thus, as shown in FIG. 2, the author and journal features only before the “current year” are obtained to rank papers published in the current year. The labels are also obtained for a fixed time (e.g., 5 years) after “current year”.

In one implementation, a gradient-boosted decision tree was trained with LambdaRank loss. This model is also known as LambdaMART (Burges C J, “From ranknet to lambdarank to lambdamart: An overview,” Learning, Jun. 23, 2010, 11 (23-581), 81). The training proceeds by considering sessions in which a sample of N papers with relevance labels are provided and the model aims to maximize the normalized discounted cumulative gain (NDCG) ranking metric. In another implementation, the mean square error (MSE) on normalized citation counts was minimized using a neural network regression model.

To evaluate the performance of various ranking models, the following performance metrics were considered.
(1) AuROC of Top 5000 and Bottom 5000 papers: From a test set of 100,000 papers, the 5000 lowest cited documents were selected and labeled with 0. The 5000 highest cited documents were selected and labeled with 1. The area under the receiver operating curve (“AuROC”) is computed for this set of 10,000 documents based on the predicted score of the ranking model.
(2) AuROC of mid-level papers: From the test set of 100,000 documents, 5000 documents with citation counts between 3 and 10 were randomly sampled and labeled with 0. Another 5000 documents with citation counts >50 were randomly selected and labeled with 1. The AuROC is computed for this set of 10,000 documents based on the predicted score of ranker and the procedure is averaged over 5 runs.
(3) NDCG@K averaged over samples of N papers, where K is the number of top-ranked papers sorted by impact score.
(4) Precision@K averaged over samples of N papers.
(5) Recall of Top@K averaged over samples of N papers.

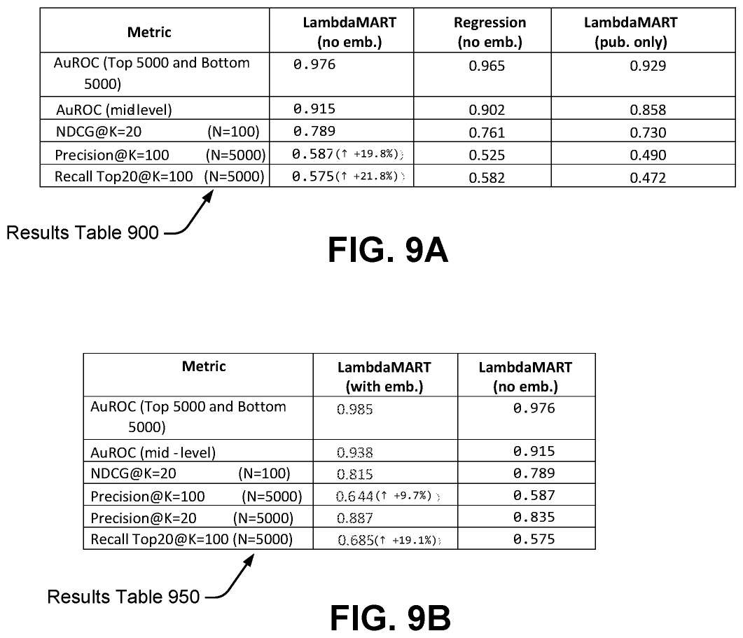

FIG. 9A shows a results table 900, which compares the LambdaMART implementation to the regression implementation on test data from Year 2017. All of the results in results table 900 were obtained without using embeddings of the title and abstracts of the papers. The “LambdaMART (no emb.)” reflects results obtained with LambdaMART using document metadata features 104, author features 110, and publication (e.g., journal) features 112. The “Regression (no emb.)” reflects results obtained with a neural network regression model with document metadata features 104, author features 110, and publication features 112. Note that the LambdaMART ranker obtained overall improved performance compared to the regression based ranker. The “LambdaMART (pub. only)” column reflects results obtained by the LambdaMART ranker with only publication features 112, and does not perform as well as LambdaMART with the additional features.

FIG. 9B shows a results table 950, which shows results for LambdaMART using text embeddings 108 of the abstract and title, document metadata features 104, author features 110, and publication features 112 in the column “LambdaMART (with emb.).” The column “LambdaMART (no emb.)” shows results for LambdaMART results for LambdaMART using document metadata features 104, author features 110, and publication features 112 without the text embeddings. As can be seen in FIG. 9B, incorporating the text embeddings leads to a significant boost in performance.

### Additional Implementations

The description above provided certain examples that were based on a particular type of document—published academic papers—that tend to appear in scientific journals or other academic publications. Academic papers often have certain characteristics that may be different from characteristics of other types of documents, such as web pages, blogs, or word processing documents. As a consequence, different types of features than those described above may be useful for other types of documents.

For instance, academic papers tend to have multiple authors. Some of the author features 110 described above are aggregated as minimum, maximum, or average values over multiple authors. These author features may be omitted for other types of documents. Instead, for instance, blog author features could reflect how often the blog author adds new blog entries, or web page author features could reflect how often the web page is updated. As another example, when a web page, blog, or word processing document is hosted on a particular website that hosts multiple web pages, that website can be treated as a “publication” by using features reflecting the number of hyperlinks to that website for model training and/or inference.

As another example, in academic papers, references to other documents are often provided as citations in the form of endnotes or footnotes. However, in web pages, blogs, or word processing documents, hyperlinks are often employed instead. Thus, some implementations can use the number of hyperlinks to a given webpage as a reference count label. For training purposes, hyperlink counts rather than citation counts can be employed. In some cases, a regression model can predict future hyperlink counts to a given web page and the predicted hyperlink counts can be employed for ranking purposes.

Furthermore, note that the description above utilized text embeddings representing the title and/or abstract of a given document. In other implementations, other document fields (e.g., the main body of a web page) can be represented as an embedding that is employed as a feature. As another example, some implementations can input an entire document into a generative language model (such as GPT) and request a summary of the document. The generated summary can then be mapped to one or more embeddings that are used as features for training and/or inference.

### Technical Effect

The disclosed techniques provide approaches for efficiently predicting the future impact of a given document. By using a machine learning model to predict the future impact of a document, several technical advantages are provided. First, an alternative approach that involves waiting for a document to receive citations from other documents would also involve a significant time delay before document impact can be determined. Furthermore, even once a given document has been referenced by other documents (e.g., after having been published for a number of years), there are significant computing resources involved in identifying the other documents that include a reference to that document. For instance, network, storage, memory, and processing resources can all be utilized on an ongoing basis to continually identify new references to a given document. Since the documents that include the new references can appear on a wide range of web services, it is far from trivial to accurately keep track of new references to a given document.

The disclosed techniques provide a lightweight approach that enables document impact to be predicted well in advance of a document actually receiving citations. Furthermore, by using a machine learning approach, document impact can be predicted without utilizing computing resources to identify and process other documents that cite to a newly-published document. In some cases, a given document can continue to be ranked relative to other documents based on its predicted impact score even after that document has been published for some time and accrued a number of references in other documents.

In some cases, ranking model is periodically retrained as additional documents become available over time. However, note that the retraining does not necessarily need to be performed for every document for which the model is employed to predict future impact. Rather, a subset of documents can be employed for model training and then the model can be employed for inference of the predicted impact of a much larger set of documents. This, in turn, saves significant computing resources that would otherwise be employed if the model were retrained on every document for which inference was performed.

Furthermore, the disclosed indexing and database storage approaches provide several additional technical advantages. By using a machine learning model to predict document impact scores and then storing those scores in a database with metadata for each document, efficient document retrieval can be performed using the metadata for filtering. The impact scores can be retrieved from the database at that time, thus allowing for low-latency ranking of the retrieved documents relative to one another. As a final point, the indexing and database storage techniques described herein can be flexibly integrated into a graphical user interface with respective interface elements that can be used to specify keywords and/or filtering criteria in a dynamic manner.

### Device Implementations

As noted above with respect to FIG. 6, system 600 includes several devices, including a client device 610, a server 620, a server 630, and a server 640. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 650. Without limitation, network(s) 650 can include one or more local area networks (LANs), wide area networks (WANs), the Internet, and the like.

### Additional Examples

Various device examples are described above. Additional examples are described below. One example includes a computer-implemented method comprising accessing a plurality of first documents, determining respective impact scores of the first documents based on references to the first documents in other documents, obtaining first features relating to the first documents, inputting the first features to a machine learning model, training the machine learning model to predict the respective impact scores of the first documents based on the first features, and outputting the trained machine learning model, the trained machine learning model being adapted to predict second impact scores of second documents based on second features relating to the second documents.

Another example can include any of the above and/or below examples where the machine learning model is a gradient-boosted decision tree.

Another example can include any of the above and/or below examples where the training is based on ranking loss for predicted rankings of individual first documents relative to one another by the machine learning model based on the first features.

Another example can include any of the above and/or below examples where the method further comprises determining reference counts of other documents to the first documents, converting the reference counts to relevance labels, and determining the ranking loss as a normalized discounted cumulative gain for the predicted rankings relative to actual rankings of the individual first documents determined using the relevance labels.

Another example can include any of the above and/or below examples where the machine learning model is a neural network.

Another example can include any of the above and/or below examples where the training is based on a mean squared error metric for predicted numbers of references to the first documents, the predicted numbers of references being predicted by the machine learning model based on the first features.

Another example can include any of the above and/or below examples where the first features relate to authors of the first documents and the second features relate to authors of the second documents.

Another example can include any of the above and/or below examples where the first features relate to publications in which the first documents appeared and the second features relate to publications in which the second documents appeared.

Another example can include any of the above and/or below examples where the first features include text embeddings of text from the first documents and the second features include text embeddings of text from the second documents.

Another example can include any of the above and/or below examples where the first features relate to metadata of the first documents and the second features relate to metadata of the second documents.

Another example can include any of the above and/or below examples where the method further comprises periodically obtaining further documents and retraining the machine learning model based on the further documents.

Another example can include any of the above and/or below examples where the references include citations to the first documents or links to the first documents.

Another example includes a method comprises obtaining a trained machine learning model that has been trained to predict respective impact scores of first documents based on first features relating to the first documents, obtaining second features relating to second documents, inputting the second features to the trained machine learning model, receiving, from the trained machine learning model, predicted impact scores reflecting predicted impacts of the second documents, receiving a query, identifying individual second documents that match the query, ranking the individual second documents relative to one another based on the predicted impact scores, and responding to the query with ranked individual second documents.

Another example can include any of the above and/or below examples where the method further comprises populating a database with the predicted impact scores, populating an index with the second documents, matching the query against the index to retrieve the individual second documents that match the query, and retrieving individual predicted impact values from the database for the individual second documents to perform the ranking.

Another example can include any of the above and/or below examples where the method further comprises performing a keyword similarity search using one or more query terms of the query to identify the individual second documents in the index.

Another example can include any of the above and/or below examples where the index is populated with embeddings representing titles and abstracts of the second documents

Another example can include any of the above and/or below examples where the method further comprises filtering the individual second documents by author, publication, and/or publication date.

Another example can include any of the above and/or below examples where the first documents and the second documents are associated with a particular subject matter domain.

Another example includes a system comprising a processor and a storage medium storing instructions which, when executed by the processor, cause the system to obtain a trained machine learning model that has been to predict respective impact scores of first documents based on first features relating to the first documents, obtain second features relating to second documents, input the second features to the trained machine learning model, receive, from the trained machine learning model, predicted impact scores reflecting predicted impacts of the second documents, receive a query, identify individual second documents that match the query, rank the individual second documents relative to one another based on the predicted impact scores, and respond to the queries with ranked individual second documents.

Another example can include any of the above and/or below examples where the first documents were published during a first time period and the second documents were published during a second time period occurring after the first time period.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
accessing a plurality of first documents;
determining respective impact scores of the first documents based on references to the first documents in other documents;
obtaining first features relating to the first documents;
inputting the first features to a machine learning model;
training the machine learning model to predict the respective impact scores of the first documents based on the first features; and
outputting the trained machine learning model, the trained machine learning model being adapted to predict second impact scores of second documents based on second features relating to the second documents.

2. The method of claim 1, the machine learning model being a gradient-boosted decision tree.

3. The method of claim 2, the training being based on ranking loss for predicted rankings of individual first documents relative to one another by the machine learning model based on the first features.

4. The method of claim 3, further comprising:
determining reference counts of other documents to the first documents;
converting the reference counts to relevance labels; and
determining the ranking loss as a normalized discounted cumulative gain for the predicted rankings relative to actual rankings of the individual first documents determined using the relevance labels.

5. The method of claim 1, the machine learning model being a neural network.

6. The method of claim 5, the training being based on a mean squared error metric for predicted numbers of references to the first documents, the predicted numbers of references being predicted by the machine learning model based on the first features.

7. The method of claim 1, the first features relating to authors of the first documents and the second features relating to authors of the second documents.

8. The method of claim 1, the first features relating to publications in which the first documents appeared and the second features relating to publications in which the second documents appeared.

9. The method of claim 1, the first features including text embeddings of text from the first documents and the second features including text embeddings of text from the second documents.

10. The method of claim 1, the first features relating to metadata of the first documents and the second features relating to metadata of the second documents.

11. The method of claim 1, further comprising:
periodically obtaining further documents and retraining the machine learning model based on the further documents.

12. The method of claim 1, the references including citations to the first documents or links to the first documents.

13. A method comprising:
obtaining a trained machine learning model that has been trained to predict respective impact scores of first documents based on first features relating to the first documents;
obtaining second features relating to second documents;
inputting the second features to the trained machine learning model;
receiving, from the trained machine learning model, predicted impact scores reflecting predicted impacts of the second documents;
receiving a query;
identifying individual second documents that match the query;
ranking the individual second documents relative to one another based on the predicted impact scores; and
responding to the query with ranked individual second documents.

14. The method of claim 13, further comprising:
populating a database with the predicted impact scores;
populating an index with the second documents;
matching the query against the index to retrieve the individual second documents that match the query; and
retrieving individual predicted impact values from the database for the individual second documents to perform the ranking.

15. The method of claim 14, further comprising:
performing a keyword similarity search using one or more query terms of the query to identify the individual second documents in the index.

16. The method of claim 14, the index being populated with embeddings representing titles and abstracts of the second documents.

17. The method of claim 13, further comprising:
filtering the individual second documents by author, publication, and/or publication date.

18. The method of claim 13, the first documents and the second documents being associated with a particular subject matter domain.

19. A system comprising:
a processor; and
a storage medium storing instructions which, when executed by the processor, cause the system to:
obtain a trained machine learning model that has been to predict respective impact scores of first documents based on first features relating to the first documents;
obtain second features relating to second documents;
input the second features to the trained machine learning model;
receive, from the trained machine learning model, predicted impact scores reflecting predicted impacts of the second documents;
receive a query;
identify individual second documents that match the query;
rank the individual second documents relative to one another based on the predicted impact scores; and
respond to the queries with ranked individual second documents.

20. The system of claim 19, wherein the first documents were published during a first time period and the second documents were published during a second time period occurring after the first time period.
